(19) United States
(12) Patent Application Publication
(10) Pub. No.: US 2026/0332039 A1
(43) Pub. Date: Oct. 22, 2026

(54) DC VOLTAGE CONVERTER APPARATUS, POWER SUPPLY SYSTEM, AND METHOD FOR DISCHARGING A DC LINK CAPACITOR

(71) Applicant: Robert Bosch GmbH, Stuttgart (DE)

(72) Inventors: Julian Veitengruber, Leinfelden-Echterdingen (DE); Roland Scheuerer, Stuttgart (DE); Wolfgang Haas, Stuttgart (DE)

(21) Appl. No.: 19/114,974

(22) PCT Filed: Aug. 9, 2023
(86) PCT No.: PCT/EP2023/072020

§ 371 Date: Mar. 25, 2025

(30) Foreign Application Priority Data
Sep. 27, 2022 (DE) 10 2022 210 192.8

(51) Int. Cl. H02M 1/32; B60L 53/20; H02J 1/12

(52) U.S. Cl. CPC H02M 1/322; B60L 53/20; H02J 1/12

(57) ABSTRACT

Discharging of energy stores, for example DC link capacitors, in a high-voltage network, in particular a high-voltage network of an electric vehicle. For this purpose, a DC voltage converter apparatus having at least two DC voltage converters is provided, wherein at least one DC voltage converter performs an energy transfer from the high-voltage network into a low-voltage network and, in parallel thereto, at least one further DC voltage converter carries out an energy transfer from the low-voltage network into the high-voltage network.

### BACKGROUND

The present invention relates to a DC voltage converter apparatus, in particular to a DC voltage converter apparatus for discharging a DC link capacitor, as well as to a method for discharging a DC link capacitor. The present invention further relates to a power supply system for an electric vehicle having such a DC voltage converter apparatus.

Fully or at least semi-electrically driven vehicles typically have at least two voltage levels. On the one hand, a low-voltage network in the range of, for example, approximately 12 V is provided, which feeds lower-power consumers. Furthermore, a high-voltage network in the range of several hundred volts is provided, which powers an electric drive system and generally also comprises a so-called traction battery.

In case of an error, it is necessary to discharge energy storage elements in the high-voltage network, such as capacitors, as quickly as possible. For this purpose, additional, separate discharge circuits can be provided, among other things.

Publication DE 10 2009 055 053 A1 describes, for example, a method and an apparatus for discharging an energy store, in particular a DC link capacitor, in a high-voltage network of a motor vehicle.

### SUMMARY

The present invention discloses a DC voltage converter apparatus, a power supply system, and a method for discharging a DC link capacitor having the features of the disclosure.

The following is therefore provided:

A DC voltage converter apparatus having a first DC voltage converter and at least one second DC voltage converter. The first DC voltage converter is configured so as to be coupled to a first DC voltage network at a first terminal. Furthermore, the first DC voltage converter is configured so as to be coupled to a second DC voltage network at a second terminal. The second DC voltage converter is configured so as to be coupled to the first DC voltage network at a first terminal. Furthermore, the second DC voltage converter is configured so as to be coupled to the second DC voltage network at a second terminal. In a first operating mode, the first DC voltage converter is configured so as to transfer electrical energy from the first terminal to the second terminal of the first DC voltage converter. Furthermore, in this first operating mode, the second DC voltage converter is configured so as to simultaneously transfer electrical energy from the second terminal to the first terminal of the second DC voltage converter.

The following is furthermore provided:

A power supply system for an electric vehicle having a high-voltage network and a low-voltage network and a DC voltage converter apparatus according to the present invention. A DC link capacitor is provided in the high-voltage network. The first terminals of the first DC voltage converter and the second DC voltage converter are electrically coupled to the high-voltage network. The second terminals of the first DC voltage converter and the second DC voltage converter are electrically coupled to the low-voltage on-board network.

Finally, the following is provided:

A method for discharging a DC link capacitor provided in a first DC voltage network. The first DC voltage network is coupled to a second DC voltage network by means of a DC voltage converter apparatus, in particular the aforementioned DC voltage converter apparatus according to the invention. The DC voltage converter apparatus comprises at least two DC voltage converters. A first DC voltage converter is coupled to the first DC voltage network at a first terminal and is coupled to a second DC voltage network at a second terminal. A second DC voltage converter is coupled to the first DC voltage network at a first terminal and is coupled to the second DC voltage network at a second terminal. In the method, the following two steps are performed simultaneously. On the one hand, electrical energy is transferred from the first terminal to the second terminal of the first DC voltage converter by means of the first DC voltage converter. On the other hand, electrical energy is transferred from the second terminal to the first terminal of the second DC voltage converter by means of the second DC voltage converter.

Electric drive systems, such as those used in electric vehicles, are typically powered by a DC voltage in the range of several hundred volts. Capacitors, in particular so-called DC link capacitors, are typically provided in order to stabilize this DC voltage. These capacitors must be able to be controlled and quickly discharged, among other things, in the event of a fault. If this is implemented by a separate, additional circuit, additional effort in the form of costs and space is required.

The present invention is based on the finding that in electric vehicles, a further low-voltage network is generally provided in addition to a high-voltage network with the electric drive system. The high-voltage network and the low-voltage network can be coupled to one another via a DC voltage converter apparatus. In this way, electrical energy can be exchanged between the high-voltage network and the low-voltage network. Because losses also occur during this energy transmission between the high-voltage network and the low-voltage network, an idea of the present invention is to realize or at least support the discharge of the capacities in the high-voltage network through the loss-prone DC voltage converter between the high-voltage network and the low-voltage network.

In this case, an apparatus is used as the DC voltage converter apparatus which includes at least two separate DC voltage converter units. A first DC voltage converter unit converts electrical energy from the high-voltage network to the low-voltage network, while in parallel, a second DC voltage converter unit converts electrical energy in the reverse direction from the low-voltage network to the high-voltage network. In this way, the electrical energy is transmitted simultaneously in both directions, with losses in the form of thermal energy also occurring in each DC voltage converter unit. Thus, the electrical energy initially stored in the capacitors of the high-voltage network can be converted into thermal energy (e.g. current heat losses) during the simultaneous DC voltage conversion in the two DC voltage converter units, thereby dissipating the electrical energy stored in the capacitors without requiring additional separate circuit units.

In many cases, DC voltage converter arrangements, such as those used for coupling the high-voltage network and the low-voltage network in an electric vehicle, are configured for bidirectional operation, i.e. for DC conversion from the high-voltage network to the low-voltage network, or vice versa from the low-voltage network to the high-voltage network. In addition, in many applications, DC voltage converter arrangements having a plurality of parallel DC voltage converter units are also provided for coupling high-voltage and low-voltage networks. The latter, for example, allows for very good scalability. For example, depending on the power to be transmitted between the high-voltage network and the low-voltage network, one or more DC voltage converter units can be activated. In this way, the active DC voltage converter units can be operated very close to their optimal operating point, thereby achieving high efficiency.

According to the invention, a further operating mode is provided in which a portion of these DC voltage converter units (at least one) is operated such that electrical energy is transmitted from the high-voltage network to the low-voltage network. At the same time, another portion of the DC voltage converter units (also at least one) is operated such that electrical energy is transferred from the low-voltage network to the high-voltage network. In this way, electrical energy is transmitted in a circular manner, so to speak. However, because all the DC voltage converter units involved experience losses during operation, a portion of the energy is converted into thermal energy. In this way, the electrical energy previously stored in capacitive elements, such as the DC link capacitor, can be dissipated and converted into thermal energy. This thermal energy can be discharged, for example, via a suitable cooling system. Because the operation usually lasts only a few seconds, the cooling system of the DC voltage converter apparatus does not need to be extended or only to a very small extent. Consequently, if necessary, the electrical energy stored in capacitors on the high-voltage network side can be quickly dissipated in this way without requiring complex additional components and measures.

According to one embodiment, the first terminals of the first DC voltage converter and the first terminals of the second DC voltage converter are each configured so as to be connected to a DC link capacitor. Furthermore, the DC voltage converter apparatus can comprise a control unit. This control unit can be configured so as to control the first DC voltage converter and the second DC voltage converter in the first operating mode in order to discharge the DC link capacitor. Thus, the control unit can specifically control and execute the discharge of the DC link capacitor.

According to one embodiment, for discharging the DC link capacitor, the control device is configured so as to set the first operating mode until an electrical voltage across the DC link capacitor drops below a predetermined threshold value. In this way, the electrical voltage across the DC link capacitor and thus in the (deactivated) high-voltage network can be reduced to a safe voltage level.

According to one embodiment, in the first operating mode, the electrical power transmitted from the first terminal to the second terminal of the first DC voltage converter is greater than the electrical power transmitted from the second terminal to the first terminal of the second DC voltage converter. In this way, it can be ensured that electrical energy is removed from the high-voltage network and the electrical energy stores present in the high-voltage network, such as the DC link capacitor. In addition to converting the electrical energy into thermal energy due to electrical losses in the DC voltage converters, it is also possible to feed electrical energy from the high-voltage network into the low-voltage network and, for example, charge a battery present in the low-voltage network or supply energy to consumers in the low-voltage network.

According to one embodiment, in the first operating mode, the electrical power supplied by the first DC voltage converter to the second terminal of the first DC voltage converter corresponds to the electrical power fed into the second terminal of the second DC voltage converter. In other words, the second DC voltage converter fully absorbs the electrical energy emitted by the first DC voltage converter. Thus, no electrical energy is fed into the second DC network. If necessary, a switching element, such as a circuit breaker or similar, can be provided between the second terminals of the first and second DC voltage converters and the second DC network. Thus, for example, in a hazardous situation, the second DC network can be electrically isolated from the DC voltage converter on one hand, and the electrical energy stored in the first DC network can be dissipated through the electrical losses in the DC voltage converters on the other hand. However, care must be taken to ensure that the electrical voltage at the second terminals of the DC voltage converters remains within specified voltage ranges and, in particular, does not exceed a maximum limit value.

According to one embodiment, the second DC network comprises a first DC sub-network and a second DC sub-network. In this case, the first DC voltage converter can be configured so as to be coupled to the first DC sub-network of the second DC network at the second terminal of the first DC voltage converter. Furthermore, the second DC voltage converter can be configured so as to be coupled to the second DC sub-network of the second DC network at the second terminal of the second DC voltage converter. In other words, the first DC voltage converter and the second DC voltage converter are each connected to separate DC sub-networks. Thus, the individual DC voltage distribution networks can be supplied with electrical power independently via separate DC voltage transformers. Furthermore, the DC voltage converter apparatus can comprise a coupling element. This coupling element is configured so as to electrically couple the first DC voltage sub-net and the second DC voltage sub-net together in the first operating mode. Thus, in this first operating mode, electrical energy can be exchanged on the second connectors of the DC voltage converter. This allows the power supplied by the first DC voltage converter to the second DC voltage converter to be fed into the second terminal of the second DC voltage converter and, in this way, the electrical power stored in the first DC voltage network is dissipated by the electrical losses in the two DC voltage converters.

According to one embodiment, the first DC voltage network comprises a first sub-net and a second sub-net. Here, the first DC voltage converter can be configured so as to be coupled to the first sub-network of the first DC voltage network at the first terminal of the first DC voltage converter, and the second DC voltage converter can be configured so as to be coupled to the second sub-network of the first DC voltage network at the first terminal of the second DC voltage converter. In other words, the two DC voltage converters can each be connected to separate sub-networks of the first DC voltage network at the first terminals. Furthermore, the DC voltage converter apparatus can comprise a coupling element. This coupling element can be configured so as to electrically couple the first sub-network and the second sub-network of the first DC voltage mesh to one another in the first operating mode. Thus, on the one hand, the two DC voltage converters can be supplied with electrical power in normal operation from separate sub-networks. Furthermore, for the discharge of electrical energy according to the invention in the first operating mode, the two sub-networks can be electrically coupled to one another.

According to one embodiment, the first DC voltage converter and/or the second DC voltage converter is configured so as to alternately transfer electrical energy from the first DC voltage network to the second DC voltage network and from the second DC voltage network to the first DC voltage network. In particular, the periods for changing the transmission direction of the electrical energy can be selected to be relatively short. For example, the change can occur regularly with a period duration of a few milliseconds, 10 ms, or 100 ms. In particular, a maximum amount of energy can be transferred that can be absorbed by the respective DC voltage network, especially the second DC voltage network. In this way, the electrical energy in the first DC voltage network can also be dissipated by means of a single DC voltage converter, for example in the event of a failure of one of the two DC voltage converters.

According to one embodiment, a second operating mode is provided in the DC voltage converter apparatus. In this second operating mode, the first DC voltage converter and/or the second DC voltage converter is configured so as to transfer electrical energy from the first terminal to the second terminal of the first DC voltage converter. Furthermore, in a third operating mode, the first DC voltage converter and/or the second DC voltage converter can be configured so as to transfer electrical energy from the second terminal to the first terminal of the first DC voltage converter. These can be, for example, operating modes used in order to conventionally transfer electrical power either from the high-voltage network to the low-voltage network or vice versa from the low-voltage network to the high-voltage network.

According to one embodiment, the DC voltage converter apparatus comprises a further operating mode in which the first DC voltage converter is configured so as to transfer electrical energy alternately from the first terminal to the second terminal of the first DC voltage converter and electrical energy from the second terminal to the first terminal of the second DC voltage converter. Thus, a discharging of the electrical energy stored on the high-voltage network side by only one DC voltage converter is also possible, for example, if the second DC voltage converter cannot be used due to a malfunction or the like.

The above embodiments and further developments can be combined with one another in any desired manner insofar as advantageous. Additional embodiments, further developments, and implementations of the invention also include inventive feature combinations not described or explicitly specified hereinabove or hereinafter with respect to exemplary embodiments. The skilled person will in particular also add individual aspects as improvements or additions to the respective basic forms of the invention.

### BRIEF DESCRIPTION OF THE DRAWINGS

Further features and advantages of the invention are explained hereinafter with reference to the drawings. Shown are:

FIG. 1: A schematic illustration of a block diagram of an arrangement of a power supply network having a DC voltage converter apparatus according to one embodiment;

FIG. 2: A schematic illustration to show the power flow through a DC voltage converter apparatus in an operating mode;

FIG. 3: A schematic illustration to show the power flow through a DC voltage converter apparatus in a further operating mode;

FIG. 4: A schematic illustration to show the power flow through a DC voltage converter apparatus in an operating mode for discharging the DC link capacitor;

FIG. 5: A schematic illustration of a block diagram of an arrangement of a power supply network having a DC voltage converter apparatus according to a further embodiment;

FIG. 6: A schematic illustration of a block diagram of an arrangement of a power supply network having a DC voltage converter apparatus according to a further embodiment;

FIG. 7: a flow chart that forms the basis for a method according to one embodiment.

### DETAILED DESCRIPTION

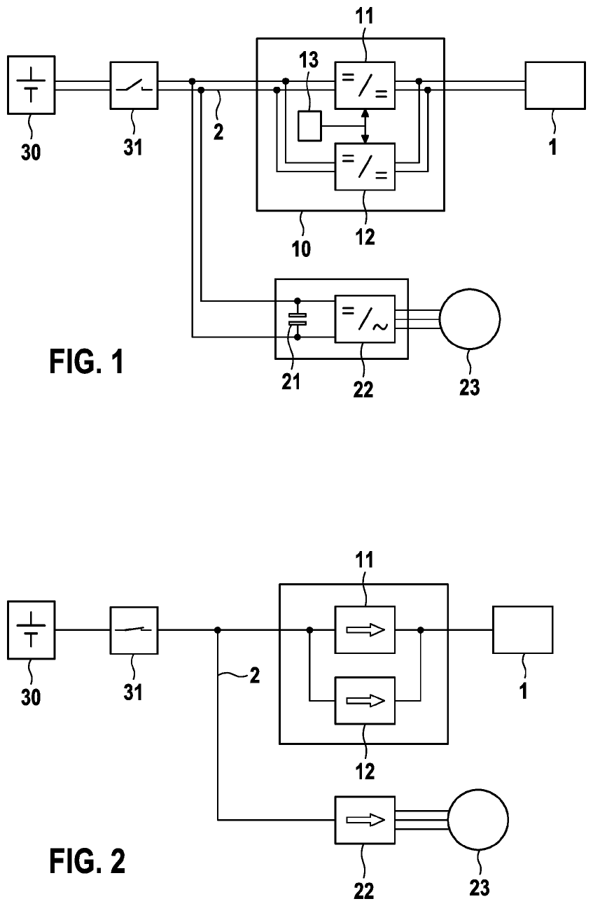

FIG. 1 shows a schematic illustration of a block diagram of a DC voltage converter apparatus 10 for coupling a high-voltage network 2 to a low-voltage network 1. The high-voltage network 2 and the low-voltage network 1 can, for example, be the corresponding on-board networks of an electric vehicle. For example, electrical consumers such as control units, ventilation, comfort functions, multimedia components, or similar can be supplied with electrical power by the low-voltage network 1. The electrical voltage of the low-voltage network 1 is typically a maximum of 48 V, typically approximately 12 or 24 V.

For example, the high-voltage network 2 can comprise an electric drive system with an electric machine 23. For example, a DC voltage of the high-voltage network 2 can be converted into a single-phase or multi-phase alternating voltage by means of an electric power converter 22, which is suitable for controlling the electrical machine 23 according to the target value specifications. To stabilize the DC voltage at the input of the power converter 22, a DC link capacitor 21 can be provided, for example. The electric voltage in the high-voltage network 2 can be several hundred volts. For example, the electrical voltage in the high-voltage network 2 can lie in the range from 350 to 400 V or 800 V.

Furthermore, an electrical energy store, for example a traction battery 30, which is coupled to the high-voltage network 2 via a circuit breaker 31, can be provided in the high-voltage network 2.

The low-voltage network 1 and the high-voltage network 2 can be electrically coupled to one another by means of a DC voltage converter apparatus 10. In particular, the DC voltage converter apparatus 10 can be an apparatus that enables bidirectional DC voltage conversion between the low-voltage network 1 and the high-voltage network 2. In other words, the DC voltage converter apparatus 10 can transmit electrical energy from the high-voltage network 2 to the low-voltage network 1, as well as electrical energy from the low-voltage network 1 to the high-voltage network 2.

As further shown in FIG. 1, the DC voltage converter apparatus 10 can comprise a plurality of units having DC voltage converters 11, 12. The number of two DC voltage converters 11, 12 shown here is to be understood merely as an example to explain the basic principle of the invention and is not intended to represent a limitation of the present invention. In addition, three or more units of DC voltage converters are also possible.

The individual DC voltage converters 11, 12 can be configured so as to be identical or at least similar. Alternatively, it is also possible that the individual DC voltage converters 11, 12 are configured differently and, in particular, are configured for different maximum power transmission. By using a plurality of parallel DC voltage converters 11, 12, for example, the number of active DC voltage converters can be adjusted based on the electrical power to be transmitted. In this way, the DC voltage converters can be operated as close to their optimal operating point as possible. Thus, the efficiency of the DC voltage converters can be increased.

FIG. 2 shows a schematic representation of the power flow in an operating mode where, for example, electrical power is provided by the traction battery 30. In this case, the circuit breaker 31 between the traction battery 30 and the high-voltage network 2 is closed. The electrical energy can be used to drive the electric machine 23 via the power converter 22. In addition, electrical energy supplied by the traction battery 30 can also be transferred into the low-voltage network 1 by means of the DC voltage converter apparatus 10 in order to supply power to electrical consumers in the low-voltage network 1 and/or to recharge a battery in the low-voltage network 1. As already indicated above, one or more DC voltage converters 11, 12 can actively perform a DC voltage conversion from the high-voltage network 2 to the low-voltage network 1.

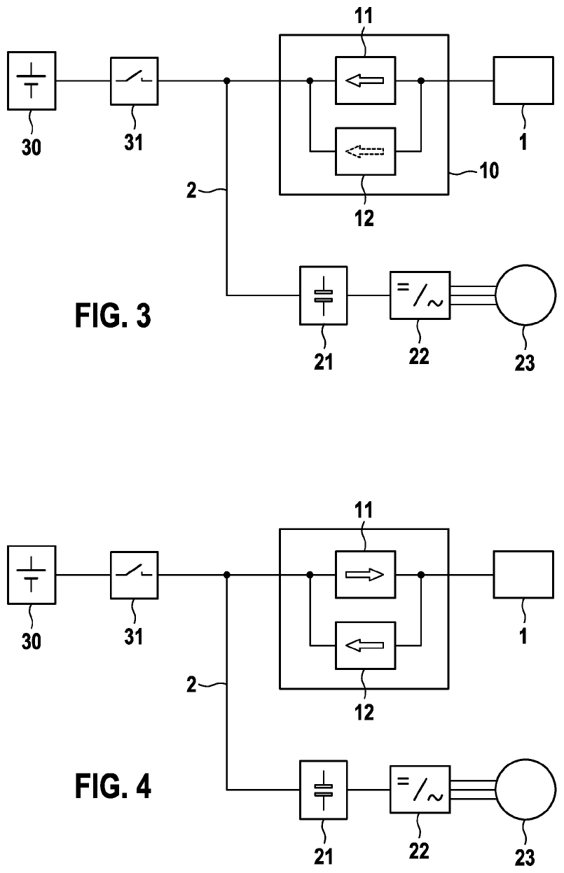

FIG. 3 shows a schematic illustration of the power flow in another operating mode, in which, for example, electrical energy is transferred from an energy store in the low-voltage network 1 to the high-voltage network 2. In this case, the circuit breaker 31 is open between the traction battery 30 and the high-voltage network 2. For example, such an power flow can recharge the DC link capacitor 21 in the high-voltage network 2. Thus, the electrical voltage in the high-voltage network 2 can be adjusted to match the electrical voltage of the traction battery 30. The circuit breaker 31 can then be closed without a significant current flowing at the time of closing. In this way, spark formation or similar effects can be avoided when closing the circuit breaker 31.

Finally, FIG. 4 shows a schematic illustration of the power flow in another operating mode according to the invention. In this case, the circuit breaker 31 is open between the traction battery 30 and the high-voltage network 2. Immediately after opening this circuit breaker switch 31, the DC link capacitor 21 is still charged. For active discharging of the DC link capacitor 21, at least one DC voltage converter 11, 12 of the DC voltage converter apparatus 10 can transfer electrical energy from the high-voltage network and thus from the DC link capacitor 21 to the low-voltage network 1. If the transferred electrical energy cannot be fully absorbed or consumed in the low-voltage network 1, then at least one additional DC voltage converter 11, 12 can convert electrical energy from the low-voltage network 1 towards the high-voltage network 2. In this case, electrical energy is simultaneously transferred from the high-voltage network 2 to the low-voltage network 1 with one set of DC voltage converters 11, 12, and from the low-voltage network 1 to the high-voltage network 2 with another set of DC voltage converters 11, 12.

Because the DC voltage converters 11, 12 are components subject to losses, the DC voltage conversion results in losses. In this process, electrical energy is converted into thermal energy. Consequently, during the simultaneous voltage conversion from the high-voltage network 2 to the low-voltage network 1 and back to the high-voltage network 2, electrical energy is continuously converted into thermal energy. Thus, the electrical energy stored in the high-voltage network 2, for example, the electrical energy in the DC link capacitor 21, is gradually dissipated and converted into thermal energy. This thermal energy can be dissipated from the DC voltage converters 11, 12 using corresponding cooling devices.

Thus, the electrical energy in the high-voltage network 2 can be dissipated even if little or no electrical energy can be absorbed by the low-voltage network 1.

Even when the low-voltage network 1 can absorb a portion of the electrical energy from the high-voltage network 2, additional electrical energy can be dissipated through simultaneous voltage conversion from the high-voltage network 2 to the low-voltage network 1 and vice versa from the low-voltage network 1 to the high-voltage network 2. Thus, rapid discharge of the electrical energy stored in the high-voltage network 2 can occur. Typically, this process will occur within a few seconds to actively discharge the high-voltage network 2 or the capacities in the high-voltage network 2. In particular, the operation for reducing the electrical energy from the high-voltage network 2 can be carried out until the electrical voltage in the high-voltage network 2 drops below a specified threshold value.

For example, a control device 13 can be provided to control the DC voltage converters 11, 12 in the previously described operating model. Depending on the operating mode, this control device 13 can specify target values for the direction of the voltage converters as well as the output voltage level on the individual DC voltage converters 11, 12.

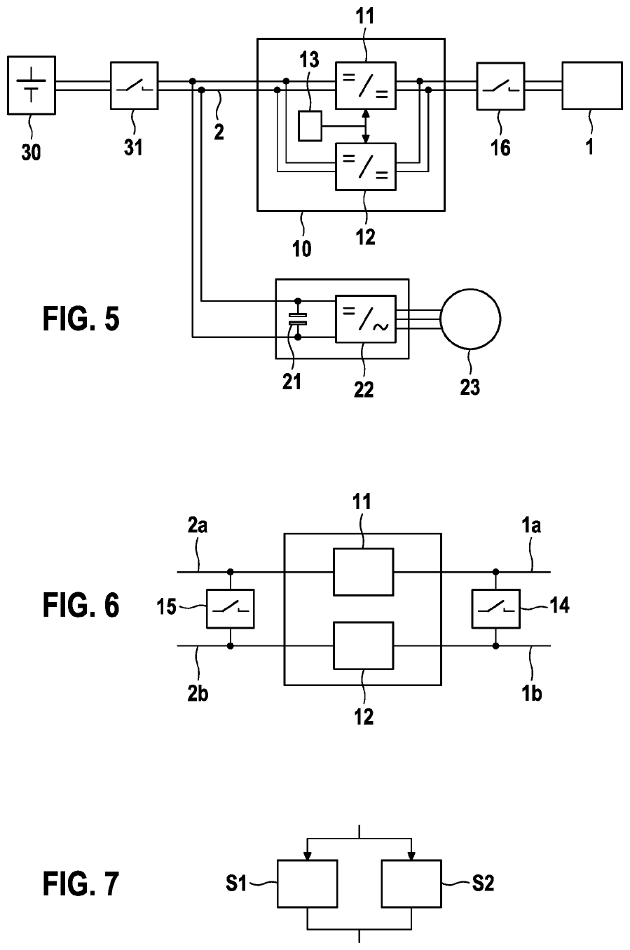

FIG. 5 shows a schematic illustration of a block diagram of a DC voltage converter apparatus 10 according to a further embodiment. The DC voltage converter apparatus 10 of this embodiment differs from the previously described embodiments primarily in that an additional isolation element 16, for example a circuit breaker or similar, can be provided between the DC voltage converter apparatus 10 and the low-voltage network 1. This isolation element 16 can electrically connect or disconnect the low-voltage network 1 to the DC voltage converter apparatus 10. In particular, in a hazardous situation, an opening of the isolation element 16 is possible in order to prevent further power flow into the low-voltage network 1. In addition, all statements already made in connection with the DC voltage converter apparatus 10 apply.

Instead of the isolation element 16 described above between the DC voltage converter apparatus 10 and the low-voltage network 1, it is also possible that in the event of a fault, for example as a result of an accident or the like, the electrical connection between the DC voltage converter apparatus 10 and the low-voltage network 1 is interrupted. For example, this can be due to a cable break, a torn plug, or the like. In this case, discharging of the high-voltage network 2 can occur analogously to the procedure with the isolation apparatus 16 opened.

If electrical energy from the high-voltage network 2 is to be dissipated with the isolation element 16 being opened, as previously described, the electrical energy emitted by the one DC voltage converter 11 on the low-voltage side must be completely absorbed by the other DC voltage converter 12. When regulating the DC voltage converter 11, 12, it must be ensured that the electric voltage on the side of the low-voltage network 1 moves within an allowable range of values. In particular, the DC voltage converters 11, 12 must be regulated such that the output voltage does not exceed a maximum allowable value.

FIG. 6 shows a schematic illustration of a block diagram of a DC voltage converter apparatus 10 according to a further embodiment. The DC voltage converter apparatus 10 of this embodiment differs from the previously described embodiments in particular in that the DC voltage converter 11, 12 on the high-voltage network side and/or the low-voltage side are respectively connected to separate high-voltage network sub-networks 2a, 2b and low voltage network sub-networks 1a, 1b. Preferably, the respective high-voltage network sub-networks 2a, 2b have at least approximately the same electrical voltage level, and also the respective low-voltage network sub-networks 1a, 1b preferably have at least approximately the same electrical voltage level.

Further, these embodiments are provided with coupling elements 14, 15, which can electrically connect the sub-networks 2a, 2b and la, 1b on the low-voltage side and the high-voltage side, respectively. If, for example, several sub-networks la, 1b are provided on the low-voltage side, these sub-networks la, 1b can be electrically connected to one another by means of the coupling element 14. Similarly, several sub-networks 2a, 2b on the high-voltage side can be electrically connected to one another by means of a coupling element 15. In particular, the respective sub-networks la, 1b or 2a, 2b can be electrically connected to one another when electrical energy in the high-voltage network 2 or one of the sub-networks 2a, 2b is to be dissipated on the high-voltage side, as has already been explained in connection with the previous exemplary embodiments.

For example, the coupling element 15 between the sub-networks 2a, 2b on the high-voltage side can comprise a 400/800V battery switch, such as those used for 800V high-voltage on-board networks for charging at 400V DC charging stations. Here, modules of the traction battery 30 are changed from serial to parallel circuitry. This corresponds to a connection of the high-voltage sub-networks 2a, 2b analogous to a closed coupling element 15.

Furthermore, it is also possible to arrange two or more DC voltage converter apparatuses 10 in parallel to one another. In this way, a plurality of forward and reverse feed paths as well as disconnecting and coupling paths can be created between the sub-networks 2a, 2b and 1a, 1b on the low-voltage side and the high-voltage side, respectively. Thus, a plurality of DC voltage converters 11, 12 can be present in total.

In the preceding embodiment, in order to reduce the electrical energy stored in the high-voltage network 2, at least one DC voltage converter 11, 12 converts electrical energy from the high-voltage network 2 towards the low-voltage network 1, while simultaneously at least one other DC voltage converter 11, 12 converts electrical energy from the low-voltage network 1 towards the high-voltage network 2.

In addition, a further operating mode can be provided in which at least one DC voltage converter 11, 12 periodically alternates transmitting electrical energy first from the high-voltage network 2 to the low-voltage network 1 and then from the low-voltage network 1 to the high-voltage network 2. In this way, the electrical energy in the high-voltage network 2 can also be dissipated when only one DC voltage converter 11 or 12 is available, for example, because the other DC voltage converter 11 or 12 has failed. Thus, for example, a type of emergency operation is possible in the event of a DC voltage converter 11 or 12 failure. The individual periods for the alternating transmission of electrical energy between the high-voltage network 2 and the low-voltage network 1 should be selected to be as brief as possible. This can prevent the electric voltage, in particular on the low-voltage side 2, from reaching too high a value and potentially exceeding a maximum limit value. In this operating mode, it is also essential to ensure that electrical voltages remain within specified value ranges and do not exceed maximum limit values.

FIG. 7 shows a flow chart on which a method for discharging a DC link capacitor according to one embodiment is based. The method can be carried out with a DC voltage converter apparatus 10, as described above in connection with FIG. 1 to 6. In particular, the method can comprise any steps as previously explained in connection with FIG. 1 to 6 for the operation of the DC voltage converter apparatus 10. Analogously, the DC voltage converter apparatus 10 described above can also comprise any components required in order to implement the method described below.

To discharge the electrical energy in the high-voltage network 2, in particular to discharge a DC link capacitor 21 in the high-voltage network 2, the following two steps are carried out simultaneously.

In step S1, a DC voltage conversion is carried out from the high-voltage network 2 to the low-voltage network 1. At least one DC voltage converter 11, 12 of the DC voltage converter apparatus 10 carries out the mentioned DC conversion from the high-voltage network 2 to the low-voltage network 1.

Simultaneously, in step S2, a DC conversion from the low-voltage network 1 to the high-voltage network 2 takes place. At least one additional DC voltage converter 11, 12 of the DC voltage converter apparatus 10 performs the DC conversion from the low-voltage network 1 to the high-voltage network 2.

The described DC conversions can be carried out at least until an electrical voltage in the high-voltage network 2, and thus across the DC link capacitor 21, drops below a specified threshold value.

In summary, the present invention relates to discharging energy stores in a high-voltage network. For this purpose, a DC voltage converter apparatus having at least two DC voltage converters is provided, wherein at least one DC voltage converter performs an energy transfer from the high-voltage network into a low-voltage network and, in parallel thereto, at least one further DC voltage converter carries out an energy transfer from the low-voltage network into the high-voltage network.

1. A DC voltage converter apparatus (10), having:
a first DC voltage converter (11) configured to be coupled to a first DC voltage network (2) at a first terminal and to a second DC voltage network (1) at a second terminal; and
a second DC voltage converter (12) configured to be coupled to the first DC voltage network (2) at a first terminal and to the second DC voltage network (1) at a second terminal;
wherein, in a first operating mode, the first DC voltage converter (11) is configured to transfer electrical energy from the first terminal to the second terminal of the first DC voltage converter (11), and the second DC voltage converter (12) is configured so as to simultaneously transfer electrical energy from the second terminal to the first terminal of the second DC voltage converter (12).

2. The DC voltage converter apparatus according to claim 1, wherein the first terminals of the first DC voltage converter (11) and the second DC voltage converter (12) are configured to be connected to a DC link capacitor (21), and wherein the DC voltage converter apparatus (10) comprises a control device (13) configured to drive the first DC voltage converter (11) and the second DC voltage converter (12) in the first operating mode for discharging the DC link capacitor (21).

3. The DC voltage converter apparatus according to claim 2, wherein, for discharging the DC link capacitor (21), the control device (13) is configured to set the first operating mode until an electrical voltage across the DC link capacitor (21) drops below a predetermined threshold value.

4. The DC voltage converter apparatus (10) according to claim 1, wherein, in the first operating mode, an electrical power transmitted from the first terminal to the second terminal of the first
DC voltage converter (11) is greater than an electrical power transmitted from the second terminal to the first terminal of the second DC voltage converter (12).

5. The DC voltage converter apparatus (10) according to claim 1, wherein, in the first operating mode, an electrical power supplied by the first DC voltage converter (11) to the second terminal of the first DC voltage converter (11) corresponds to an electrical power supplied to the second terminal of the second DC voltage converter (12).

6. The DC voltage converter apparatus (10) according to claim 1, wherein the second DC voltage network (1) comprises a first DC voltage sub-network (1a) and a second DC voltage sub-network (1b),
wherein the first DC voltage converter (11) is configured to be coupled to the first DC voltage sub-network (la) of the second DC voltage network (1) at the second terminal of the first DC voltage converter (11), and the second DC voltage converter (12) is configured so as to be coupled
to the second DC voltage sub-network (1b) of the second DC voltage network (1) at the second terminal of the second DC voltage converter (12), and
wherein the DC voltage converter apparatus (10) comprises a coupling element (14) configured so as to electrically couple the first DC voltage sub-network (1a) and the second DC voltage sub-network (1b) in the first operating mode.

7. The DC voltage converter apparatus (10) according to claim 1, wherein the first DC voltage network (2) comprises a first sub-network (2a) and a second sub-network (2b),
wherein the first DC voltage converter (11) is configured so as to be coupled to the first sub-network (2a) of the first DC voltage network (2) at the first terminal of the first DC voltage converter (11), and the second DC voltage converter (12) is configured so as to be coupled to the second sub-network (2b) of the first DC voltage network (2) at the first terminal of the second DC voltage converter (12), and
wherein the DC voltage converter apparatus (10) comprises a further coupling element (15) configured to electrically couple the first sub-network (2a) and the second sub-network (2b) of the first DC voltage network (2) to one another in the first operating mode.

8. The DC voltage converter apparatus (10) according to claim 1,
wherein, in a second operating mode, the first DC voltage converter (11) and/or the second DC voltage converter (12) are configured to transfer electrical energy from the first DC voltage network (2) to the second DC voltage network (1), and
in a third operating mode, the first DC voltage converter (11) and/or the second DC voltage converter are configured to transfer electrical energy from the second DC voltage network (1) to the first DC voltage network (2).

9. The DC voltage converter apparatus (10) according to claim 1,
wherein, in a further operating mode, the first DC voltage converter (11) is configured to transfer electrical energy in an alternating manner from the first terminal to
the second terminal of the first DC voltage converter (11) and from the second terminal to the first terminal of the second DC voltage converter (11).

10. An electric vehicle, having:
a high-voltage network (2) with a DC link capacitor (21);
a low-voltage network (1); and
a DC voltage converter apparatus (10) according to claim 1,
wherein the first terminals of the first DC voltage converter (11) and the second DC voltage converter (12) are electrically coupled to the high-voltage network (1), and
wherein the second terminals of the first DC voltage converter (11) and the second DC voltage converter (12) are electrically coupled to the low-voltage network.

11. A method for discharging a DC link capacitor (21) in a first DC voltage network (2) by means of a DC voltage converter apparatus (10), which comprises at least two DC voltage converters (11, 12), wherein a first DC voltage converter (11) is coupled to the first DC voltage network (2) at a first terminal and is coupled to a second DC voltage network (1) at a second terminal, and a second DC voltage converter (12) is coupled to the first DC voltage network (2) at a first terminal and is coupled to the second DC voltage network (1) at a second terminal, and wherein, in the method, the following steps are performed simultaneously:
transmitting (S1) electrical energy from the first terminal to the second terminal of the first DC voltage converter (11), and transferring (S2) electrical energy from the second terminal to the first terminal of the second DC voltage converter (12).
